(19) United States
(12) Patent Application Publication
(10) Pub. No.: US 2001/0049607 A1
(43) Pub. Date: Dec. 6, 2001

(54) Network marketing system confirming the intention to purchase items in a shopping cart sequentially for each item

(76) Inventors: Hisashi Tanaka, Tokyo (JP); Hitoshi Nagashima, Tokyo (JP)

Correspondence Address: McGuire Woods, Suite 1800, 1750 Tysons Boulevard, McLean, VA, 22102, US

(21) Appl. No.: 09/872,004

(22) Filed: Jun. 4, 2001

(30) Foreign Application Priority Data
Jun. 5, 2000 (JP) 2000-167669

(51) Int. Cl. G06F 17/60

(52) U.S. Cl. 705/1

(57) ABSTRACT

The disclosed network marketing system sequentially confirms a user's intention to purchase items for each item in a shopping cart. A marketer server adds items that have been selected by a user terminal to a shopping cart that is stored in a shopping cart database. Upon receiving notification from the user terminal of the intention to purchase items in the shopping cart, the marketer server sequentially presents items in the shopping cart to the user terminal to confirm the intention to purchase, and then actually accepts the purchase of only those items for which the intention to submit for purchase could be confirmed. The user can place items that he or she still has not definitely decided to buy in the shopping cart rather than being limited to placing in the shopping cart only those items that he or she has actually decided to purchase, and the user therefore does not need to separately record information regarding items he or she considers buying.

### BACKGROUND OF THE INVENTION

1. Field of the Invention

The present invention relates to a network marketing system and method in which articles are marketed by way of the Internet, and more particularly to a network marketing system and method in which a shopping cart is used for temporarily holding articles that a user is considering for purchase.

2. Description of the Related Art

Network marketing systems for marketing articles by way of the Internet have come into use in recent years. Using this type of network marketing system enables a user to participate in online shopping that allows the purchase of a wide variety of products without the need to actually visit a store. A user who intends to purchase articles using this type of network marketing system operates a user terminal to connect by way of the Internet to a server that is managed by a marketer. The user can then purchase items by browsing the home page of the marketer, selecting from among the items that are being marketed on the home page those items that he or she wishes to purchase, and then applying to purchase the items.

If a plurality of items are to be purchased in this type of network marketing system, the user must take the time and trouble to repeatedly select and apply for purchase for each of the items he or she wishes to purchase.

Furthermore, once an application to purchase an item has been made, the application to purchase generally cannot be easily canceled. As a result, even when the user finds an item that meets all his conditions, the user typically takes into the consideration the possibility that he or she will find a still better item, and therefore does not immediately apply to purchase the item but rather, records a memo of the item's price and item code. Then, after browsing a variety of home pages and examining a plurality of items, if the user should decide to purchase an item that was found earlier, he or she must return to the home page in which the item was posted to apply for purchase.

When purchasing a plurality of items, a user that intends to keep the total price of the items he or she buys within a fixed figure must keep note of items he or she wishes to purchase along with their prices and then select purchase items such that the total price stays within the fixed figure.

Since items that are marketed by a marketer server are presented on a plurality of home pages, this operation becomes even more time-consuming.

In order to solve this type of problem, network marketing systems in recent years have employed a shopping cart for temporarily holding items that a user intends to purchase, as disclosed in Japanese Patent National Publication Laid-open No. 10-509543 (U.S. Pat. No. 5,715,314).

This type of shopping cart is a memory area that temporarily holds items that a user intends to purchase, and the user is thus able to browse various home pages and place items he or she wishes to purchase into this shopping cart. Finally, applying to purchase the items inside the shopping cart all at once not only eliminates the time and trouble entailed in applying for each single item, but also enables the user to know the total price of a plurality of items before purchase.

The operation of this type of network marketing system of the prior art is explained using the flow chart of FIG. 1.

First, in Step 201, the user places items in the cart by browsing various home pages and selecting items that he or she wishes to buy. FIG. 2 shows an example of the display of items that are held in a cart by this type of process. This screen allows the user to view the items that are held inside the shopping cart, and by selecting “Continue Shopping” on this screen, the user can select additional items.

When the user has completed the selection of items to purchase, the screen of FIG. 2 is displayed, and in Step 202, the purchase of all items in the cart is determined by the selection of “Apply to Purchase All Items.” The application to purchase all items in the cart is thus realized all at once in Step 203.

This type of network marketing system of the prior art can eliminate the time and trouble entailed by applying to purchase items one item at a time. However, the shopping cart in this network marketing system of the prior art is still a save area that is based on the assumption of an eventual application to purchase items, and it is assumed that the user will not use it to hold a plurality of purchase candidate items. This is because the application to purchase all items that are held in the shopping cart is realized when “Apply to Purchase All Items” is selected. Thus, in a case in which a user intending to purchase a particular item browses a home page, considers a plurality of items as purchase candidates, and then finally actually buys only one item, it is assumed that the user keeps a separate record by, for example, taking notes of purchase candidate items without placing them in the shopping cart, and then places only the item that he or she ultimately decides to purchase into the shopping cart and applies for purchase.

In other words, in a network marketing system of the prior art in which a purchase application is performed for all items that are held in a shopping cart in a single operation, the shopping cart is used for holding only those items that the user has actually decided to purchase, and for items that the user wishes only to investigate as possible purchase items, the user must therefore take the time and trouble to, for example, separately record items.

### SUMMARY OF THE INVENTION

It is an object of the present invention to provide a network marketing system in which items that are being investigated for possible purchase can be held in shopping cart.

To realize the above-described object, the network marketing system of the present invention is provided with: at least one user terminal that is operated by a user who purchases items and that has the capability to connect to a network, an item database, a shopping cart database, and a marketer server.

The item database records information on items that are being marketed. The shopping cart database stores a shopping cart for each user for temporarily saving items that a user is investigating for purchase. The marketer server is connected to the network and provides to the user terminal item information that is recorded in the item database. Upon receiving notification from the user terminal to add a particular item to the shopping cart, the marketer server adds that item to the shopping cart that is stored in the shopping cart database. Upon receiving notification from the user terminal of the intention to purchase items in the shopping cart, the marketer server sequentially presents items in the shopping cart to the user terminal to confirm the intention to purchase, and actually accepts purchases only with respect to items for which an application to purchase could be confirmed.

According to the present invention, a user's intention to purchase is confirmed for each item that is held in a shopping cart rather than performing a purchase application for all items held in a shopping cart in a single operation. As a result, the user is able to hold in the shopping cart items that he or she still has not yet definitely decided to purchase, and the user is not limited to holding in the shopping cart only those items that he or she has actually decided to purchase. Accordingly, the user can avoid the trouble of, for example, separately recording information regarding items before placing the items in the shopping cart.

Furthermore, in comparison with a case in which the purchase application is accepted for all items at once as in a network marketing system of the prior art, the network marketing system of the present embodiment can prevent mistakes in the purchase application of items that the user does not intend to purchase.

In a case in which a user has placed a particular item in a shopping cart, the network marketing system of the present invention may also maintain the right of the user to purchase preferentially that particular item.

According to the present invention, when purchasing a marketed item that is limited in number, a user can establish his or her priority to purchase the item by placing the item in the shopping cart, and the user can therefore adequately investigate whether or not he or she wishes to purchase the item without having to hurry to purchase.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a flow chart showing the operation of a network marketing system of the prior art;

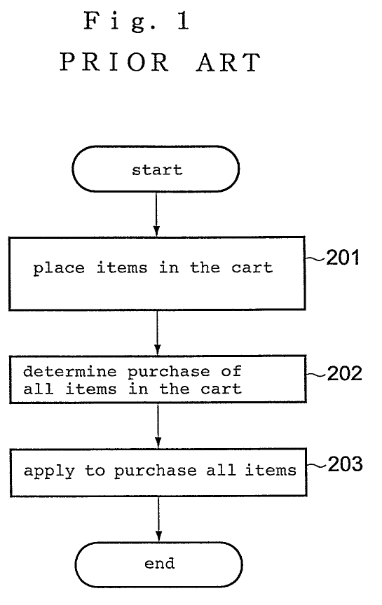

FIG. 2 shows an example of a display screen showing the contents of a shopping cart in the network marketing system of the prior art;

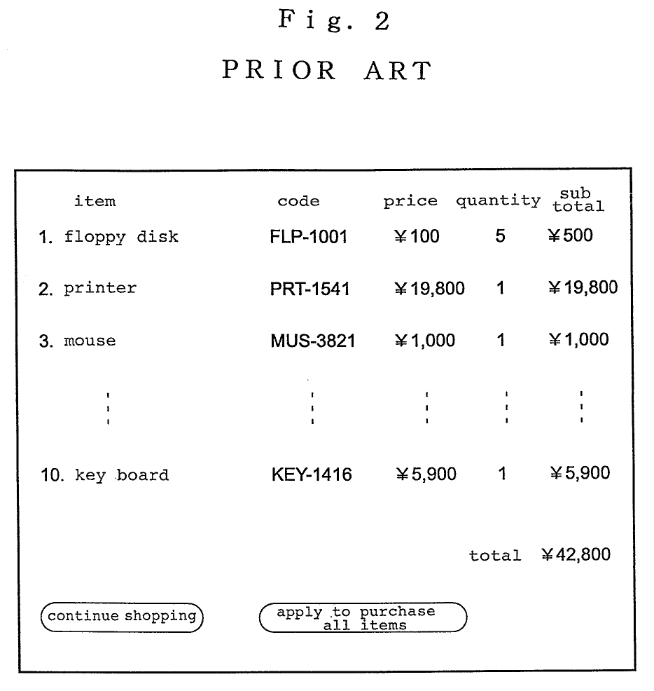

FIG. 3 is a block diagram showing the architecture of a network marketing system according to an embodiment of the present invention;

FIG. 4 is a flow chart showing the operation of a network marketing system according to an embodiment of the present invention;

FIG. 5 shows an example of a display screen that shows the contents of a shopping cart in the network marketing system according to an embodiment of the present invention; and

FIG. 6 shows an example of a display screen in a network marketing system according to an embodiment of the present invention.

### DETAILED DESCRIPTION OF THE PREFERRED EMBODIMENTS

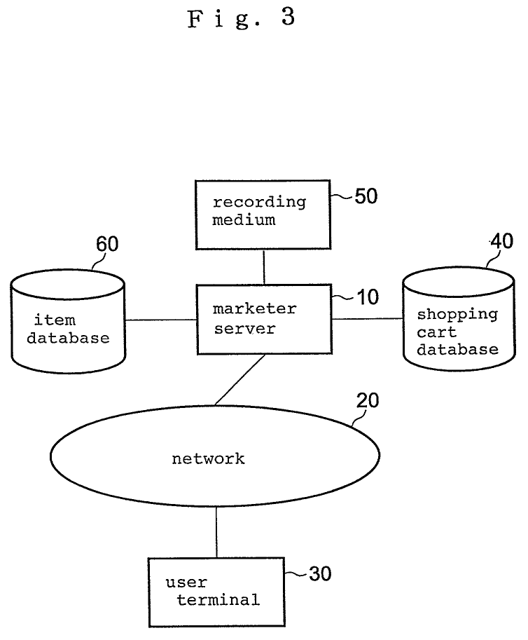

Referring now to FIG. 3, the network marketing system according to an embodiment of the present invention is provided with: marketer server 10, network 20 such as the Internet, user terminal 30, shopping cart database 40, recording medium 50, and item database 60. Although, in the interest of simplifying the explanation, a case is described in this embodiment in which there is only one user terminal, a plurality of user terminals may be connected to marketer server 10 by way of network 20.

A program for executing the network marketing method according to the present embodiment is recorded on recording medium 50, and this program is read from recording medium 50 to marketer server 10 and then controls the operation of marketer server 10. Marketer server 10 executes the above-described processes under the control of this program. This recording medium 50 may be a magnetic disc, a semiconductor memory, or other recording medium.

Item database 60 is connected to marketer server 10 and records information such as information on items that are being marketed and their prices.

User terminal 30 is operated by the user that purchases items and has the capability to connect to network 20.

Shopping cart database 40 is connected to marketer server 10 and stores shopping carts for each user.

Marketer server 10 is connected to network 20; provides item information that is recorded in item database 60 to user terminal 30; upon receiving notification from user terminal 30 of the intent to add a particular item to the shopping cart, adds that item to the shopping cart that is stored in shopping cart database 40; upon receiving notification from user terminal 30 of the intent to purchase items in the shopping cart, sequentially presents items in the shopping cart to user terminal 30 to confirm the intention to purchase; and actually accepts purchase only for those items for which the intent to apply for purchase could be confirmed.

Although not shown in the figures, a backup means may also be provided for holding the functions of marketer server 10, the information that is stored in marketer server 10 and the information that is recorded in item database 60, shopping cart database 40, and recording medium 50.

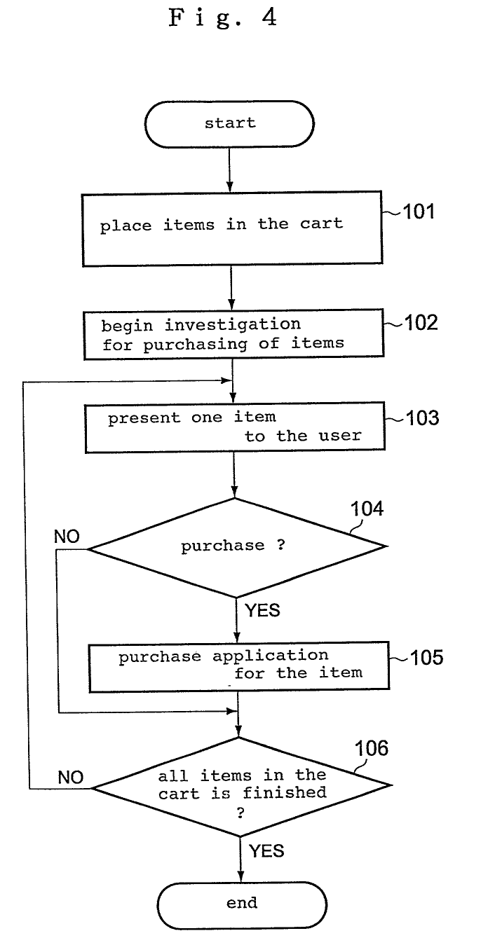

Referring now to the flow chart of FIG. 4, the operation of the network marketing system of this embodiment is next explained.

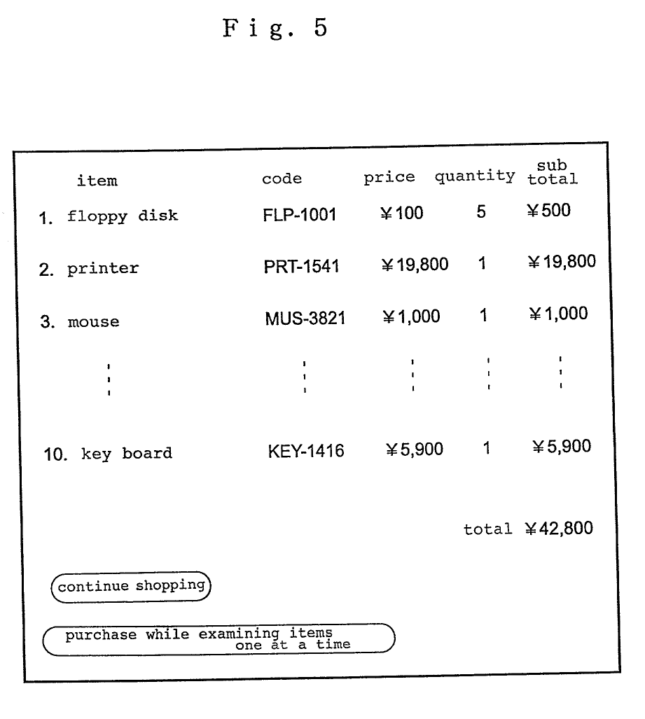

First, the user operates user terminal 30 to connect to marketer server 10, browses various home pages, selects an item to purchase, and then notifies marketer server 10 to place this item in a shopping cart. Marketer server 10 then saves this item in the shopping cart that corresponds to that user among the shopping carts that are stored in shopping cart database 40 in Step 101. FIG. 5 shows an example of the display of a plurality of items that have been saved in a shopping cart by this type of process. This type of screen allows the user to view the items that are saved in the shopping cart, and further, allows the user to view detailed information on an item by clicking on the item. The user can select still other items by selecting “Continue Shopping” on this screen.

Upon completing the selection of items for purchase, the user causes the display of the screen shown in FIG. 5, and then selects “Apply to purchase while examining items one at a time” in Step 102. Marketer server 10 then selects one of the items in shopping cart and presents it to the user in Step 103 to confirm whether or not the user intends to purchase that item in Step 104. Marketer server 10 then deletes the presented item from the shopping cart.

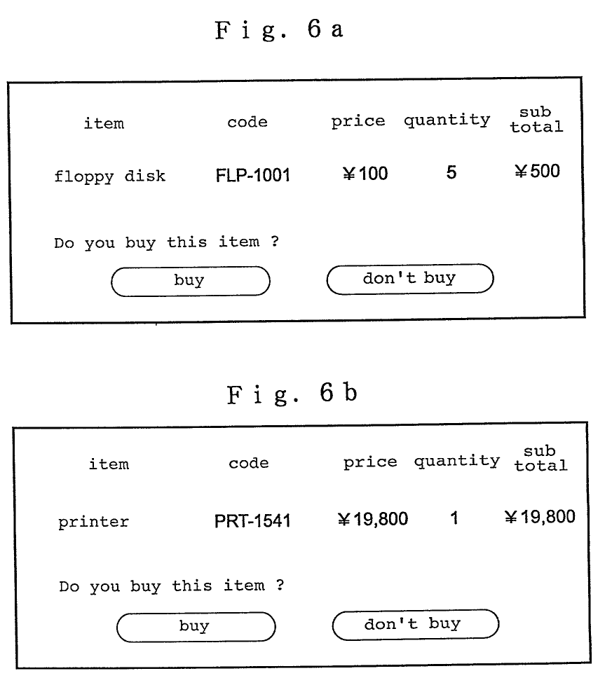

If items are held in the shopping cart such as shown in FIG. 5, a screen such as shown in FIG. 6 is displayed. Confirmation of the user's intent to purchase is then realized by having the user select either “Buy” or “Don't Buy.”

If the user selects “Don't Buy” in Step 104, the process proceeds to Step 106 without applying for the purchase of that item. If the user selects “Buy” in Step 104, the purchase application for that item is performed in Step 105.

It is next checked in Step 106 whether all items in the shopping cart have been completed, and if there are still items in the cart, the next item is presented in Step 103 as shown in FIG. 6b. Processing equivalent to the above-described description is carried out in Steps 104 and 105, and in this way, the processes from Step 103 to Step 105 are carried out until no items remain in the shopping cart, whereupon the process ends in Step 106.

Thus, when “Purchase while examining items one at a time” is selected in the network marketing system of this embodiment, the user's intention to purchase is confirmed for each item that is saved in the cart rather than making an application to purchase all items that are saved in the cart in a single operation. Accordingly, the user can save items in the shopping cart that he or she has still not definitely decided to buy, rather than saving only those items that he or she has actually decided to buy, and the user can thus save the time needed for separately recording information on items before saving them in the shopping cart.

In addition, compared to a case of accepting the purchase application for all items at once as in the network marketing system of the prior art, confirming the user's intention to purchase one item at a time in the network marketing system of this embodiment further prevents mistaken purchase applications of items that the user does not intend to buy.

From the user's point of view as well, the item-by-item confirmation of the intention to purchase items when applying to purchase gives the user an opportunity to re-examine the necessity of the items and can prevent the purchase application of unneeded items.

Furthermore, when purchasing, for example, items that are marketed in a limited number, a later attempt to purchase may fail because the stipulated number of items has already been sold. A user attempting to purchase items that are being marketed in a limited number may be compelled to apply for purchase without having adequately compared the items with other items. To deal with this problem, priority may be assigned to a purchase at the time items are saved in the shopping cart, whereby the user can purchase items that are limited in number after adequate examination and without undue haste, and the above-described problem can be eliminated.

As described in the foregoing explanation, the present embodiment can provide a network marketing system in a form that is closer to an actual shopping experience in an ordinary department store or supermarket in which the user decides on the items he or she ultimately purchases by placing items in and removing items from a shopping cart.

While a preferred embodiment of the present invention has been described using specific terms, such description is for illustrative purposes only, and it is to be understood that changes and variations may be made without departing from the spirit or scope of the following claims.

What is claimed is:

1. A network marketing system comprising:
at least one user terminal for being operated by a user that purchases items and having the capability to be connected to a network;
an item database for storing information on items on the market;
a shopping cart database each associated with each user for storing shopping carts to temporarily save items to be investigated for purchase by a user; and
a marketer server connected to said network, for providing said user terminal with item information stored in said item database, for adding a particular item to a shopping cart stored in said shopping cart database upon receiving notification from said user terminal to add that item to the shopping cart, for sequentially presenting items in said shopping cart to said user terminal to confirm whether or not the user has the intention to purchase upon receiving notification from said user terminal of the intention to purchase items in the shopping cart, and for actually accepting an application to purchase only with respect to items for which intention of an application to purchase could be confirmed.

2. A network marketing system according to claim 1, wherein said user terminal establishes a right to purchase preferentially a particular item when said user saves the item in said shopping cart.

3. A network marketing method for marketing items between a marketer server and a user terminal, said server and said terminal being connected by way of a network, said method comprising steps of:
adding an item selected by said user terminal to a shopping cart for temporarily holding items to be examined by said user for purchase;
upon receiving notification from said user of the intent to purchase items in said shopping cart, sequentially presenting items in said shopping cart to said user to confirm whether or not the user has the intention to purchase; and
actually accepting an application to purchase for only those items for which said user's intention to apply for purchase could be confirmed.

4. A network marketing method according to claim 3, further comprising a step of establishing said user's right to purchase preferentially a particular item when said user saves the item in said shopping cart.

5. A computer program for enabling a computer to perform processing for marketing items between a user terminal and a marketer server, said terminal and said server being connected by way of a network, said processing comprising:
a process for adding an item selected by said user to a shopping cart for temporarily holding items to be examined by said user for purchase;
a process for sequentially presenting items in said shopping cart to said user to confirm whether or not the user has the intention to purchase upon receiving notification from said user of the intention to purchase items in the shopping cart; and
a process for actually accepting an application to purchase with respect to only those items for which said user's intention to apply for purchase could be confirmed.

6. A computer program according to claim 5 that causes a computer to execute a process such that said user establishes a right to purchase preferentially a particular item when said user saves the item in said shopping cart.

7. A marketer server that can be connected to at least one user terminal by way of a network, said server comprising:
a means for providing said user terminal with information on items that are marketed,
a means for, upon receiving notification from said user terminal to add a particular item to a shopping cart for temporarily holding items the user is examining for purchase, adding the item to said shopping cart;
a means for, upon receiving notification from said user terminal of the intention to purchase items in said shopping cart, sequentially presenting items in the shopping cart to said user terminal to confirm whether or not the used has the intention to purchase; and
a means for actually accepting application to purchase with respect to only those items for which the intention to purchase could be confirmed.
